(19) United States
(12) Patent Application Publication
(10) Pub. No.: US 2011/0302758 A1
(43) Pub. Date: Dec. 15, 2011

(54) ORNAMENTAL ARTICLE FIXING APPARATUS AND METHOD OF FIXING ORNAMENTAL ARTICLE WITH THE FIXING APPARATUS

(75) Inventor: Michitoshi Ishii, Ibaraki (JP)

(73) Assignee: JMI Co., Ltd., Chiyoda-ku (JP)

(21) Appl. No.: 12/670,919

(22) PCT Filed: Mar. 2, 2009
(86) PCT No.: PCT/JP2009/000922

§ 371 Date: Nov. 16, 2010

(51) Int. Cl. B23P 11/00; B23P 19/00

(52) U.S. Cl. 29/428; 29/700

(57) ABSTRACT

An ornamental article fixing apparatus configured to fix an ornamental article as a member to be fixed to a sheet-type fixation member including: a tubular portion arranged through the fixation member; one flange portion formed at one end portion of the tubular portion and arranged on the side of a surface portion on one side of the fixation member; and a shaft member arranged so as to penetrate through the tubular portion and having a length longer than the length of the tubular portion, in which one other flange portion is formed at one other end portion of the tubular portion by pulling the shaft member along an axial direction of the tubular portion, and the ornamental article is fixed to the fixation member by the one flange portion and the other flange portion.

### TECHNICAL FIELD

The present invention relates to an ornamental article fixing apparatus and a method of fixing an ornamental article with the fixing apparatus and, specifically, to an ornamental article fixing apparatus configured to fix an ornamental article such as a button or an ornamental member to a fixation member such as a cloth material or a leather material such as clothes, and a method of fixing an ornamental article with the fixing apparatus.

### BACKGROUND ART

In general, when fixing an ornamental article such as a button or an ornamental member such as a snap fastener to a cloth material or the like such as clothes, machines such as a hand press machine, a motor press machine, an air press machine, or an oil press machine are used.

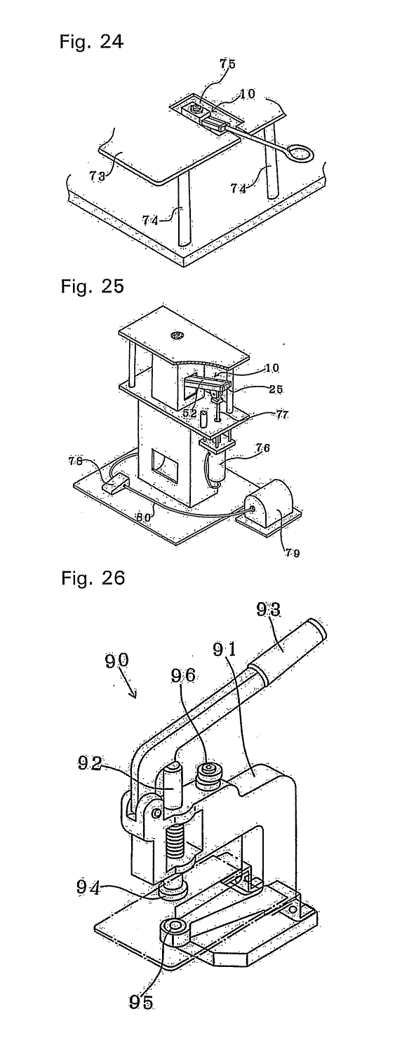

For example, a hand press machine 90 in the related art includes a hand press body 91, a piston 92 held by the hand press body 91 so as to be capable of moving upward and downward, and an operating lever 93 rotatably provided on the hand press body 91 which is capable of pressing an upper end of the piston 92 as shown in FIG. 26, is configured to press the upper end portion of the piston 92 to move downward by the rotatably provided operating lever 93, and pressurize and fix a component of the ornamental article with respect to the cloth material with a pressurizing jig 94 provided at a lower end of the piston 92 and an ornamental article receiver 95 provided below the pressurizing jig 94, and is provided with a stopper member 96 formed on the hand press body 91 so as to be capable of adjusting the height thereof for adjusting the amount of downward movement of the piston 92.

The stopper member 96 is configured in such a manner that the operating lever 93 comes into abutment with the stopper member 96 when the operating lever 93 is pressed downward, and functions to prevent the piston 92 from being pressed excessively downward and giving damage such as cracking or the like to the component of the ornamental article.

In this case, among the ornamental articles such as the button or the ornamental member such as the snap fas, there are those such as a metallic button which can bear with a predetermined pressure when being pressurized and, in contrast, those such as glass material, shells, and stones which may be broken when being applied with the predetermined pressure.

Therefore, when fixing the button or the like to the cloth material or the like by using the hand press machine 90, adjustment of the height of the stopper member 96 is required depending on the material, the type, or the like of the button or the like to be fixed, and the procedure is very complicated because such adjusting work takes time.

In other words, when performing the adjusting work as described above, it is necessary to perform a pressurizing test actually by several times by using an ornamental article so as to achieve an adequate pressurization which does not cause any damage such as the cracking or the like on the ornamental article and is able to fix the ornamental article to the cloth material or the like when performing fine adjustment of the height of the stopper member 96 of the hand press machine 90 and, in the course of the test, a number of the ornamental articles may be damaged or the ornamental articles by themselves maybe broken down, and hence there may arise a case where commercialization of product by fixing the ornamental article to the cloth material or the like by itself is difficult, or a case where a number of defective goods are produced.

In a case where the ornamental articles such as the buttons are fixed by using the hand press machine 90, it is necessary to prepare the ornamental article receiver 95 separately according to the surface shape of the ornamental article so as not to damage the surface of the ornamental article at the time of pressurization.

However, since there are various types in the surface shapes of a variety of the ornamental articles, the number of types of the ornamental article receivers 95 to be prepared according to these types is large, and hence fixing work requires high cost, and is complicated.

Also, since the fixing work is performed by pressurizing in a state in which the ornamental article receiver 95 is in abutment with the surface of the ornamental article, the surface of the ornamental article is susceptible to damage even when the ornamental article receiving member 95 corresponding to the surface shape of the ornamental article is used.

In addition, at the time of the fixing work for the ornamental article, the surface of the ornamental article is in a state of being in abutment with the ornamental article receiving member 95 on the side of a lower surface of the fixation member and hence the surface of the ornamental article cannot be viewed during the fixing work. Therefore, there are problems such that confirmation of the direction of attachment or the positional alignment of the ornamental article with respect to the cloth material is difficult and, depending on the cases, a finger is pinched by mistake between the pressurizing jig 94 and the ornamental article receiving member 95 at the time of work.

In the hand press machine 90, since the pressurization of the ornamental article with respect to the cloth material is preformed between the piston 92 as well as the pressurizing jig 94 fixed to the lower end portion of the piston 92 and the ornamental article receiving member 95, there exist the hand press body 91, the piston 92, the operating lever 93, or the like above and below the cloth material, and hence there are problems such that a working space is small, and attachment work is difficult when the cloth material or the like as the fixation member of an ornamental article is large.

### DISCLOSURE OF INVENTION

### Technical Problems

Accordingly, it is an object of the present invention to provide an ornamental article fixing apparatus which does not need complex adjusting work in fixing work with respect to a cloth material or the like as a fixation member for a variety of ornamental articles, does not damage and break the ornamental articles, and is able to secure a working space for the cloth material or the like as the fixation member and a method of fixing the ornamental article with the fixing apparatus.

### Technical Solution

In order to solve the problems as described above, the invention according to claim 1 is an ornamental article fixing apparatus configured to fix an ornamental article as a member to be fixed to a sheet-type fixation member comprising: a tubular portion arranged so as to penetrate through the fixation member; one flange portion formed at one end portion of the tubular portion and arranged on the side of a surface portion on one side of the fixation member; and a shaft member arranged so as to penetrate through the tubular portion and having a length longer than the length of the tubular portion, whereby one other flange portion is formed at one other end portion of the tubular portion by pulling the shaft member along an axial direction of the tubular portion, and the ornamental article is fixed to the fixation member by the one flange portion and the other flange portion.

Therefore, according to the invention described in claim 1, since the other flange portion is formed at the other end portion of the tubular portion by pulling the shaft member along the axial direction of the tubular portion, and the ornamental article is fixed to the fixation member by the one flange portion and the other flange portion, the ornamental article can be fixed to the fixation member easily.

The invention according to claim 2 is that the tubular portion is formed of a tubular member having the one flange portion at one end portion thereof, the shaft member has a head portion larger than an inner diameter of the tubular member and has rigidity larger than that of the tubular member, the one flange portion is arranged in an exterior of the ornamental article and the head portion is arranged in an interior of the ornamental article, the fixation member is arranged between the ornamental article and the one flange portion, the other flange portion is created by the head portion widening one other end portion of the tubular member when the shaft member is pulled in a counter-ornamental article direction along the axial direction, and the ornamental article is fixed to the fixation member via the tubular member by the one flange portion fixed to one side of the fixation member and the other flange portion fixed to the interior of the ornamental article.

Therefore, according to the invention described in claim 2, since the other flange portion is created by the head portion widening the other end portion of the tubular member when the shaft member is pulled in the counter-ornamental article direction along the axial direction, and the ornamental article is fixed to the fixation member via the tubular member by the one flange portion fixed to the one side of the fixation member and the other flange portion fixed to the interior of the ornamental article, the ornamental article can be fixed to the fixation member easily.

The invention according to claim 3 includes a placing portion on which the fixation member with the ornamental article aligned in position and arranged thereon is placed by the shaft member being penetrated therethrough; a grip member configured to grip and pull the shaft member; and an operating member configured to cause the grip member to pull.

Therefore, according to the invention described in claim 3, since the placing portion on which the fixation member is placed is provided, the fixing work for the ornamental article to the fixation member can be performed easily.

Also, since the grip member configured to grip and pull the shaft member is provided, the gripped shaft member can be pulled along the axial direction.

Also, by operating the operating member, the shaft member can be pulled along the axial direction via the gripped member.

The invention according to claim 4 is that the ornamental article includes one component part arranged on one surface portion of the fixation member and one other component part arranged on one other surface portion of the fixation member, and the tubular portion is formed on the one component part and is configured in such a manner that the other flange portion is created at the other end portion of the tubular portion when the shaft member is pulled in an other component part direction along the axial direction, and the ornamental article is fixed to the fixation member by engagement of the other flange portion with the other component part.

Therefore, according to the invention described in claim 4, since the other flange portion is created at the other end portion of the tubular portion when the shaft member is pulled in the other component part direction along the axial direction, and the ornamental article is fixed to the fixation member by the engagement of the other flange portion with the other component part, the ornamental article can be fixed to the fixation member easily.

The invention according to claim 5 is that the one component part is arranged on the side of an upper surface of the fixation member and the other component part is arranged on the side of a lower surface of the fixation member so as to oppose to each other in the vertical direction, a placing portion on which the fixation member is placed via the other component part, the grip member configured to grip and pull the shaft member arranged so as to penetrate through the one component part, the fixation member, and the other component part downward, and an operating member configured to cause the grip member to pull downward are provided, a head portion of the shaft member is arranged via a jig placed on the one component part, and the placing portion includes an abutting portion which is capable of coming into abutment with a lower end portion of the tubular portion and widening the lower end portion radially outward, and forming as the other flange portion which is capable of engaging the other component portion when the shaft member is pulled downward.

Therefore, according to the invention described in claim 5, since the placing portion on which the fixation member is placed via the other component part is provided, the fixing work for the ornamental article to the fixation member can be performed easily.

Also, since the grip member configured to grip and pull the shaft member downward is provided, the gripped shaft member can be pulled along the axial direction.

Also, by operating the operating member, the shaft member can be pulled along the axial direction via the grip member.

Also, since the head portion of the shaft member is arranged via the jig placed on the one component part, and the placing portion includes the abutting portion which is capable of coming into abutment with the lower end portion of the tubular portion and widening the lower end portion radially outward, and forming the other flange portion which is capable of engaging the other component portion when the shaft member is pulled downward, the ornamental article can be fixed to the fixation member easily.

The invention according to claim 6 is that the fixation member has a thickness smaller than the length of the tubular portion.

The invention according to claim 7 is that the fixation member is a cloth material.

The invention according to claim 8 is that the fixation member is a leather material.

The invention according to claim 9 is that the operating member is activated via a hand. The invention according to claim 10 includes: a base plate portion to be fixed on a surface of installation; a grip portion provided upright on the base plate portion and having the grip member arranged therein so as to be movable in the vertical direction; an operating lever rotatably attached to the grip portion via a shaft and being capable of pulling the grip member downward; an urging member arranged in the interior of the grip portion and being capable of urging the grip member constantly upward; and the placing portion provided at an upper end portion of the grip portion.

Therefore, according to the invention described in claim 10, the placing portion on which the cloth material or the like as the fixation member can be placed is provided on the upper end portion of the gripping portion when fixing the ornamental article to the cloth material or the like as the fixation member, and the apparatus does not exist above the placing portion, so that the cloth material or the like as the fixation member can be extended easily.

The invention according to claim 11 is that the operating member is activated via an actuator.

The invention according to claim 12 is a method of fixing an ornamental article for fixing an ornamental article as a member to be fixed to a sheet-shaped fixation member including: inserting a tubular portion into a fixation member and arranging a flange portion formed at one end portion of the tubular portion on the side of a surface portion on one side of the fixation member; arranging a shaft member having a length larger than that of the tubular portion so as to penetrate through the tubular portion; forming one other flange portion at one other end portion of the tubular portion by pulling the shaft member along the axial direction of the tubular portion; and fixing the ornamental article to the fixation member by the one flange portion and the other flange portion.

Therefore, according to the invention described in claim 12, since the other flange portion is formed at the other end portion of the tubular portion by pulling the shaft member along the axial direction of the tubular portion, the ornamental article is fixed to the fixation member by the one flange portion and the other flange portion, the method of fixing which allows the ornamental article to be fixed easily with the ornamental article fixing apparatus is provided.

The invention according to claim 13 is that the tubular portion is formed of a tubular member having the one flange portion at one end portion thereof, the shaft member has a head portion larger than an inner diameter of the tubular member and has rigidity larger than that of the tubular member, the shaft member is arranged so as to penetrate through the fixation member by arranging the head portion in an interior of the ornamental article in a state in which the one flange portion is arranged in an exterior of the ornamental article and the fixation member is arranged between the one flange portion and the ornamental article, and the other flange portion is created by pulling the shaft member in a counter-ornamental article direction along the axial direction and causing the head portion to widen one other end portion of the tubular member, and the ornamental article is fixed to the fixation member via the tubular member by the one flange portion fixed to the one side of the fixation member and the other flange portion fixed to the interior of the ornamental article.

Therefore, according to the invention described in claim 13, since the other flange portion is created by pulling the shaft member in the counter-ornamental article direction along the axial direction and causing the head portion to widen the other end portion of the tubular member, and the ornamental article is fixed to the fixation member via the tubular member by the one flange portion fixed to the one side of the fixation member and the other flange portion fixed to the interior of the ornamental article with the ornamental article fixing apparatus, the method of fixing which allows the ornamental article to be fixed easily with the ornamental article fixing apparatus is provided.

The invention according to claim 14 is that the ornamental article includes one component part arranged on one surface portion of the fixation member and one other component part arranged on one other surface portion of the fixation member, and a step of forming the other flange portion at the other end portion of the tubular portion when the shaft member is pulled in the other component part direction along the axial direction in a state in which the tubular portion is formed on the one component part and fixing the ornamental article to the fixation member by engagement of the other flange portion with the other component part is included.

Therefore, according to the invention described in claim 14, since the step of forming the other flange portion at the other end portion of the tubular portion when the shaft member is pulled in the other component part direction along the axial direction in a state in which the tubular portion is formed on the one component part and fixing the ornamental article to the fixation member by engagement of the other flange portion with the other component part is included, the method of fixing which allows the ornamental article to be fixed easily with the ornamental article fixing apparatus is provided.

The invention according to claim 15 is that the one component part is arranged on the side of an upper surface of the fixation member and the other component part is arranged on the side of a lower surface of the fixation member so as to oppose to each other in the vertical direction, the shaft member is arranged with a head portion inserted through the one component part, the fixation member, and the other component part via a jig placed on the one component part, and a lower end portion of the tubular portion is brought into abutment with an abutting portion formed on the placing portion to widen the lower end portion radially outward to form as the other flange portion which is capable of engaging the other component part when the shaft member is pulled downward, and the fixation member is clamped by the one flange portion and the other flange portion to fix the member to be fixed to the fixation member.

Therefore, according to the invention described in claim 15, since the lower end portion of the tubular portion is brought into abutment with the abutting portion formed on the placing portion to widen the lower end portion radially outward to form as the other flange portion which is capable of engaging the other component part when the shaft member is pulled downward, and the fixation member is clamped by the one flange portion and the other flange portion to fix the member to be fixed to the fixation member, the method of fixing which allows the ornamental article to be fixed easily with the ornamental article fixing apparatus is provided.

### Advantageous Effects

According to the ornamental article fixing apparatus in the invention described in claim 1, 2, or 4, since the other flange portion is formed at the other end portion of the tubular portion by pulling the shaft member along the axial direction of the tubular portion, the ornamental article is fixed to the fixation member by the one flange portion and the other flange portion, it is not configured to pressurize the ornamental article by itself as in a hand press machine in the related art, and the adjusting work for adjusting the degree of pressurization is not necessary.

Therefore, the fixing work for the ornamental article to the fixation member is performed easily and quickly.

Consequently, the surface of the ornamental article is prevented from being damaged at the adjusting work, and even when the ornamental article is formed of a material which has no resistance when being pressurized, such as glass, synthetic resin, the fixing and adjusting work can be performed without breaking or damaging the ornamental article at all.

Also, it is not necessary to prepare the ornamental article receiving members separately according to the surface shapes, the sizes, the thicknesses, the qualities of material, or the like of the ornamental articles to be fixed to the fixation member as in the case where the fixing work for the ornamental article is performed by using the hand press machine in the related art, and hence the cost required for the fixing work can be reduced, and the complication in association with the fixing work is solved.

Also, there are ornamental articles having characters or the like on the surface thereof and hence having a specific direction to be attached with respect to the fixation member, since the apparatus is not configured to fix the ornamental article by pressurizing the same from above to the cloth material by using a piston as in the related art, but is configured to arrange on the fixation member below the ornamental article, the surface of the ornamental article can be viewed at the time of the fixing work for the ornamental article, so that the fixing work which matches the direction of attachment of the ornamental article is achieved easily.

In the ornamental article fixing apparatus in the invention described in claim 3 or 5, since the placing portion is provided and the cloth material or the like as the fixation member on which the ornamental article is aligned in position can be placed thereon, the ornamental article fixing apparatus which achieves the easy-to-work environment by preventing the work space from being narrowed and secures security is provided.

Also, since the operating member for causing the grip member to pull is provided, the shaft member is pulled along the axial direction by the grip member by operating the operating member, so that the ornamental article fixing apparatus which is capable of fixing the ornamental article easily is provided.

According to the ornamental article fixing apparatus in the invention described in claim 9, since the operating member can be operated via the hand, the ornamental article can be fixed to the cloth material or the like as the fixation member manually by the operation by a person without necessity of a variety of facilities.

According to the ornamental article fixing apparatus in the invention described in claim 6, since the fixation member is having the thickness smaller than the length of the tubular portion, the ornamental article can be fixed to the fixation member by using the ornamental article fixing apparatus according to the present invention.

According to the ornamental article fixing apparatus in the invention described in claim 7, since the fixation member is the cloth material, the ornamental article can be fixed to the cloth material by using the ornamental article fixing apparatus according to the present invention.

According to the ornamental article fixing apparatus in the invention described in claim 8, since the fixation member is the leather material, the ornamental article can be fixed to the leather material by using the ornamental article fixing apparatus according to the present invention.

In the invention described in claim 10, since the placing portion on which the cloth material or the like as the fixation member can be placed is provided at the upper end portion of the apparatus, the cloth material or the like as the fixation member can be extended easily on the apparatus, so that the easy-to-work environment is achieved, and the security of a finger of the operator at the time of the fixing work is secured.

According to the ornamental article fixing apparatus in the invention described in claim 11, since the operating member can be operated via the actuator, the ornamental article can be fixed to the cloth material or the like as the fixation member easily by the operation of the actuator.

In the ornamental article fixing method in the invention described in claims 12 to 15, since it is not configured to fix by pressurizing by using the hand press machine in the related art, the adjusting work in the apparatus for adjusting the degree of pressurization is not necessary.

Consequently, the surface of the ornamental article is prevented from being damaged at the time of the adjusting work, and even when the ornamental article is formed of a material which has no resistance when being pressurized, such as glass, synthetic resin, the fixing and adjusting work can be performed without damaging the ornamental article or breaking the ornamental article at all.

Also, it is not necessary to prepare the ornamental article receivers separately according to the surface shapes of the ornamental articles to be fixed to the fixation member as in the case where the fixing work for the ornamental article is performed by using the hand press machine in the related art, and hence the cost required for the fixing work can be reduced, and the complication caused by the fixing work is solved.

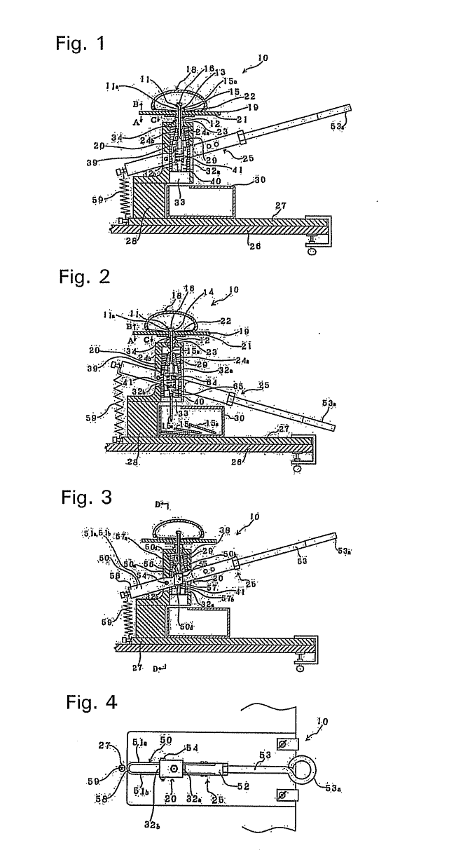

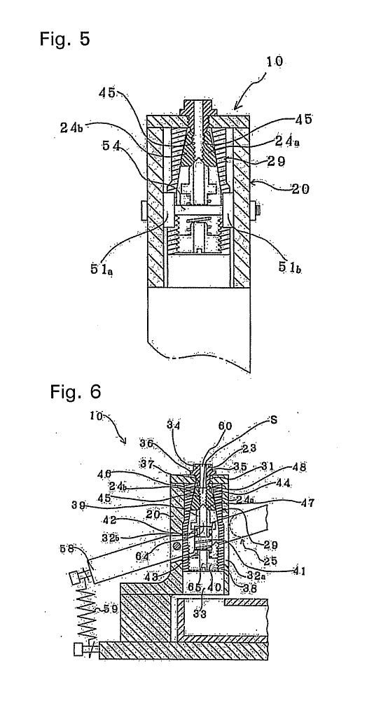

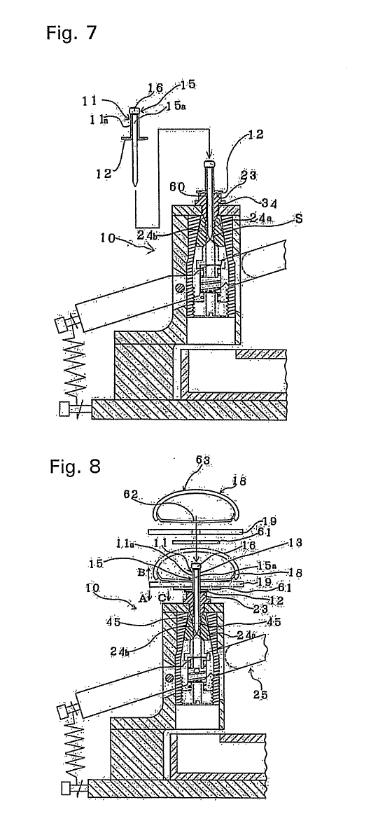

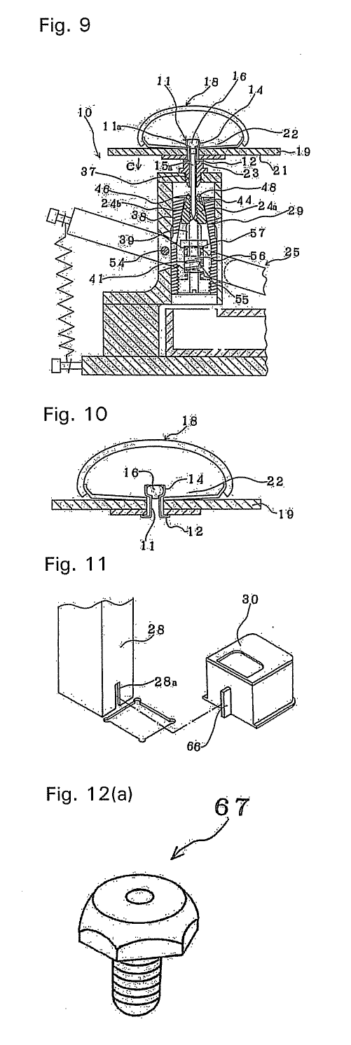

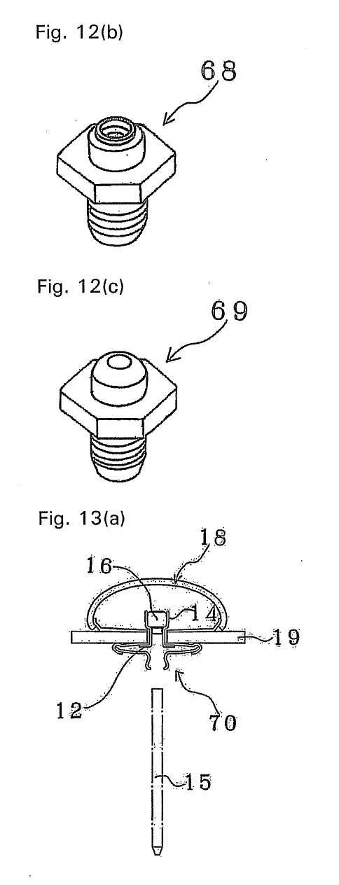

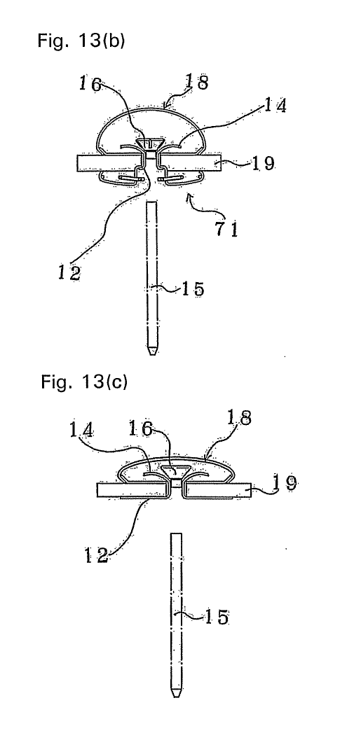

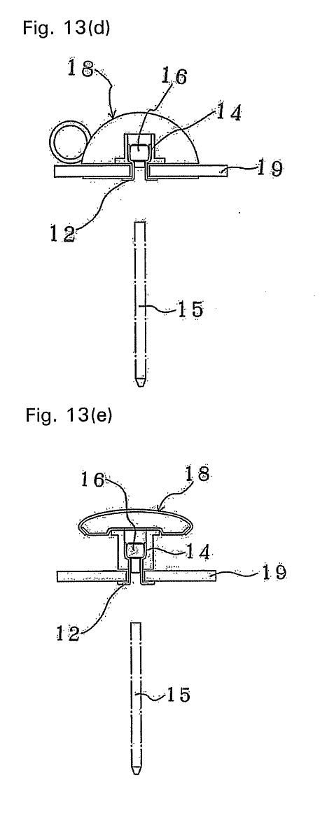

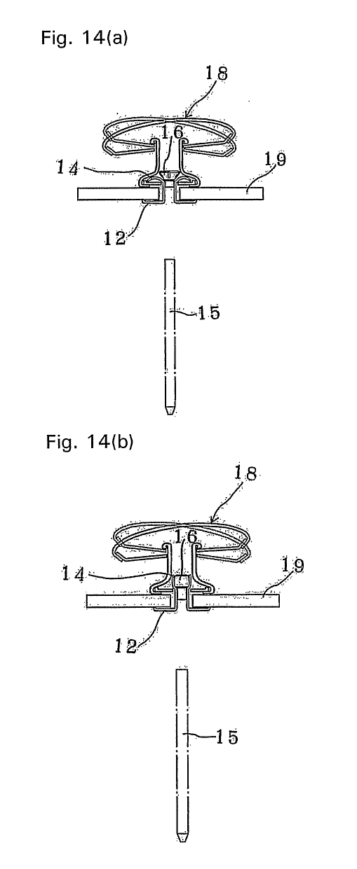

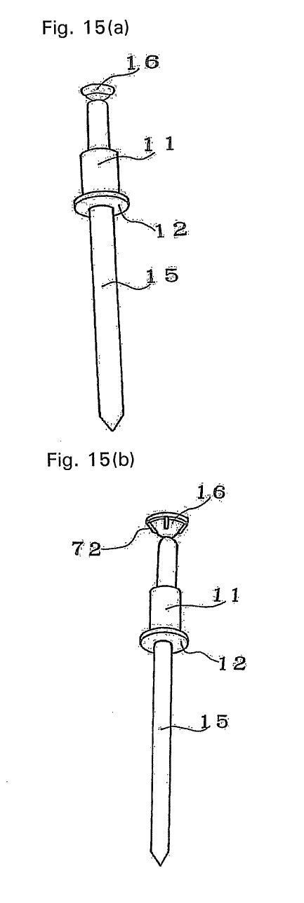

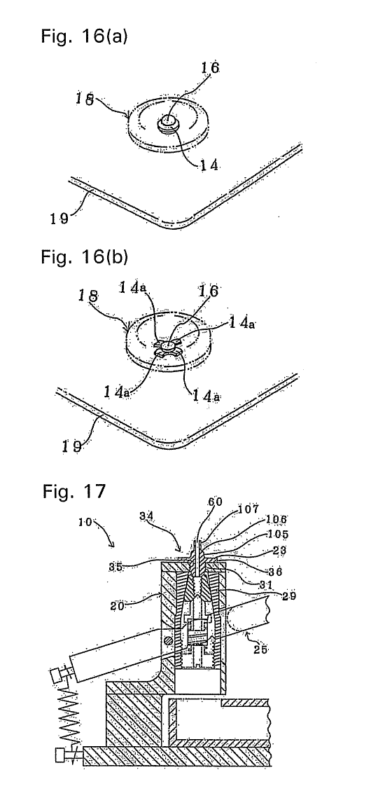

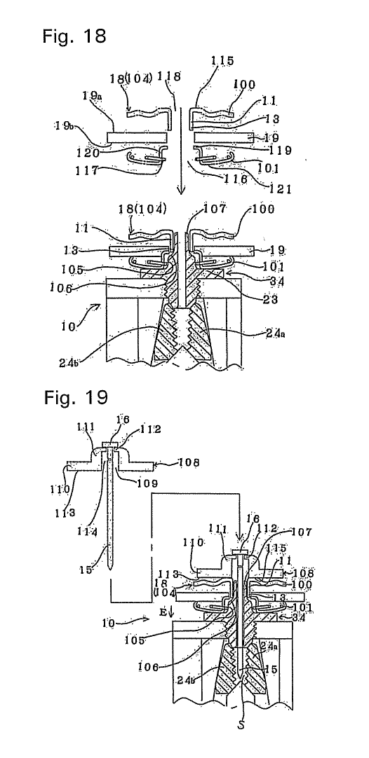

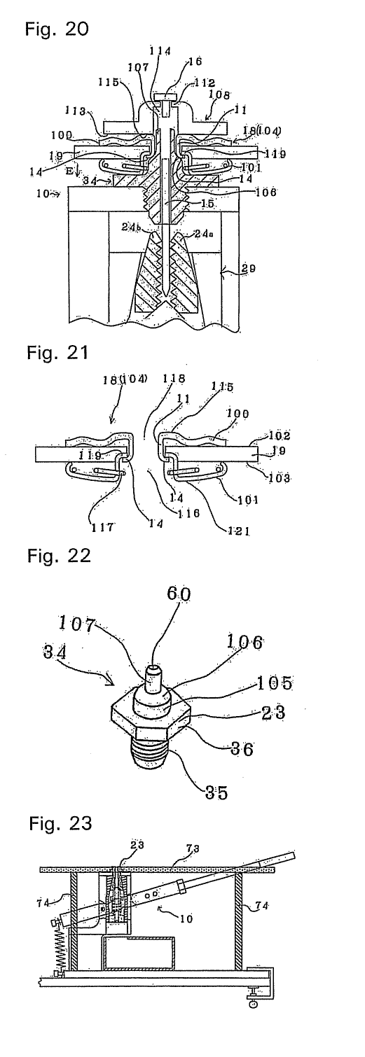

### BRIEF DESCRIPTION OF THE DRAWINGS

[FIG. 1] FIG. 1 is a cross-sectional view showing an embodiment of an ornamental article fixing apparatus according to the present invention.

[FIG. 2] FIG. 2 is a cross-sectional view showing the embodiment of the ornamental article fixing apparatus according to the present invention.

[FIG. 3] FIG. 3 is a cross-sectional view showing the embodiment of the ornamental article fixing apparatus according to the present invention.

[FIG. 4] FIG. 4 is a plan view showing the embodiment of the ornamental article fixing apparatus according to the present invention.

[FIG. 5] FIG. 5 is a cross-sectional view showing the embodiment of the ornamental article fixing apparatus according to the invention taken along the line D-D in FIG. 3.

[FIG. 6] FIG. 6 is a partly cross-sectional view showing the embodiment of the ornamental article fixing apparatus according to the present invention.

[FIG. 7] FIG. 7 is a partly cross-sectional view showing the embodiment of the ornamental article fixing apparatus according to the invention.

[FIG. 8] FIG. 8 is a partly cross-sectional view showing the embodiment of the ornamental article fixing apparatus according to the present invention.

[FIG. 9] FIG. 9 is a partly cross-sectional view showing the embodiment of the ornamental article fixing apparatus according to the present invention.

[FIG. 10] FIG. 10 is a cross-sectional view showing an embodiment of an ornamental article fixed by using the ornamental article fixing apparatus according to the present invention.

[FIG. 11] FIG. 11 is a perspective view showing an embodiment of a storage portion of the ornamental article fixing apparatus according to the present invention.

[FIG. 12] FIGS. 12(a), (b), and (c) are perspective views showing an embodiment of a placing member used in the ornamental article fixing apparatus according to the present invention.

[FIG. 13] FIGS. 13(a), (b), (c), (d) and (e) are cross-sectional views showing an embodiment of the ornamental article fixed by using the ornamental article fixing apparatus according to the present invention.

[FIG. 14] FIGS. 14(a) and (b) are cross-sectional views showing an embodiment of an ornamental article fixed by using in the ornamental article fixing apparatus according to the present invention.

[FIG. 15] FIGS. 15(a) and (b) are perspective views showing an embodiment of a fixing member used in the ornamental article fixing apparatus according to the present invention.

[FIG. 16] FIGS. 16(a) and (b) are perspective views showing an embodiment of a mounting state of the fixing member used in the ornamental article fixing apparatus according to the invention.

[FIG. 17] FIG. 17 is a partly cross-sectional view showing the embodiment of the ornamental article fixing apparatus according to the invention.

[FIG. 18] FIG. 18 is a partly cross-sectional view showing the embodiment of the ornamental article fixing apparatus according to the present invention.

[FIG. 19] FIG. 19 is a partly cross-sectional view showing the embodiment of the ornamental article fixing apparatus according to the present invention.

[FIG. 20] FIG. 20 is a partly cross-sectional view showing the embodiment of the ornamental article fixing apparatus according to the invention.

[FIG. 21] FIG. 21 is a cross-sectional view showing an embodiment of an ornamental article fixed by using the ornamental article fixing apparatus according to the present invention.

[FIG. 22] FIG. 22 is a perspective view showing an embodiment of the placing member used in the ornamental article fixing apparatus according to the present invention.

[FIG. 23] FIG. 23 is a cross-sectional view showing an embodiment of a state in which a working table is attached to the ornamental article fixing apparatus according to the present invention.

[FIG. 24] FIG. 24 is a perspective view showing the embodiment of the state in which a working table is attached to the ornamental article fixing apparatus according to the present invention.

[FIG. 25] FIG. 25 is a perspective view showing an embodiment of a state in which an actuator is attached to the ornamental article fixing apparatus according to the present invention.

[FIG. 26] FIG. 26 is a perspective view showing a hand press machine in the related art used when fixing an ornamental article to a cloth material.

### EXPLANATION OF REFERENCE

10 ornamental article fixing apparatus

11 tubular portion

11a tubular member

12 one flange portion

13 other end portion of tubular portion, lower end portion of tubular portion

14 other flange portion

14a strip of other flange portion

15 shaft member

15a shaft member

16 head portion

18 ornamental article

19 fixation member (cloth material)

19a upper surface of fixation member (cloth material)

19b lower surface of fixation member (cloth material)

20 grip portion

21 one side of fixation member

22 interior of ornamental article

23 placing portion

24a grip member

24b grip member

25 operating lever

26 fixing base

27 seat portion

28 column portion

28a slit of column portion

29 pull-down drive portion

30 collective box

31 screw hole

32a opening

33b opening

34 placing member

35 connecting tubular screw portion

36 tubular stopper strip

37 inclined surface portion

38 case portion

39 pushing-up member

40 screw member

41 coil spring

42 cylindrical projection of lower end portion of pushing-up member

43 cylindrical projection of lower end portion of member to be fixed

44 inner peripheral inclined surface

45 grip portion

46 upper inwardly inclined surface portion

47 lower inwardly inclined surface portion

48 outer peripheral inclined surface

50 u-shaped member

50a notched portion

50b notched portion

50c arcuate portion

50d arcuate portion

51a lateral side portion

51b lateral side portion

52 fixing portion

53 lever portion

53a operating side end portion

54 spindle

55 holding portion

56 cam portion

57 recessed portion

57a upper edge portion

57b lower edge portion

58 distal end portion of operating lever

59 coil spring

60 shaft insertion hole

61 washer

62 mounting hole portion of ornamental article

63 surface portion of ornamental article

64 insertion hole

65 insertion hole

66 mounting strip

67 placing member

68 placing member

69 placing member

70 male member of snap fastener

71 female member of snap fastener

72 projecting groove

73 working table

74 leg portion

75 opening

76 pneumatic cylinder, actuator

77 drive rod

78 foot switch

79 air compressor

80 air tube

90 hand press machine

91 hand press body

92 piston

93 operating lever

94 pressurizing jig

95 ornamental article member receiver

96 stopper mechanism

100 one component part

101 other component part

102 one surface portion

103 other surface portion

104 female snap fastener

105 mounting portion

106 abutting portion

107 guiding tubular portion

108 jig

109 hole portion

110 lower cylindrical portion

111 upper cylindrical portion

112 locking portion

113 press-contact surface

114 spatial portion

115 upper plain surface portion

116 mounting hole

117 snap fastener spring portion

118 insertion hole

119 engagement strip

120 male snap fastener introducing tubular portion

121 lower plain surface portion

A exterior of ornamental article

B interior of ornamental article

C counter-ornamental article direction

E other component part direction

S space

### BEST MODES FOR CARRYING OUT THE INVENTION

Referring now to the drawings, a first embodiment of an ornamental article fixing apparatus according to the present invention will be described.

FIG. 1 is a cross-sectional view of an ornamental article fixing apparatus 10 according to an embodiment of the present invention. As shown in FIG. 1 and FIG. 7, the ornamental article fixing apparatus 10 according to the present invention is the ornamental article fixing apparatus 10 which is configured to fix an ornamental article 18 such as a button as a member to be fixed to a sheet-shaped fixation member 19, includes a tubular portion 11 arranged so as to penetrate through the fixation member 19, one flange portion 12 formed at one end portion of the tubular portion 11 and arranged on the side of a surface portion on one side of the fixation member 19, and a shaft member 15 arranged so as to penetrate through the tubular portion 11a and having a length longer than the length of the tubular portion 11, is formed with one other flange portion 14 by pulling the shaft member 15 along the axial direction of the tubular portion 11 at one other end portion 13 of the tubular portion 11 as shown in FIG. 2, and is configured to fix the ornamental article 18 to the fixation member 19 by the one flange portion 13 and the other flange portion 14.

As shown in FIG. 1 and FIG. 7, the tubular portion 11 of the ornamental article fixing apparatus 10 according to the present invention is formed of a tubular member 11a having the one flange portion 12 at the one end thereof, and the shaft member 15 is formed of a shaft member 15a having a head portion 16 larger than an inner diameter of the tubular member 11a and having rigidity higher than the tubular member 11a.

As shown in FIG. 1 and FIG. 8, the one flange portion 12 is arranged in an exterior A of the ornamental article 19, the head portion 16 is arranged in an interior B of the ornamental article 18, the fixation member 19 is arranged between the ornamental article 18 and the one flange portion 12, and as shown in FIG. 2 and FIG. 9, when the shaft member 15 is pulled toward a counter-ornamental article direction C along the axial direction, the head portion 16 widens the other end portion 13 of the tubular member 11a to create the other flange portion 14, so that the one flange portion 12 is fixed to one side 21 of the fixation member 19 and the other flange portion 14 is fixed to an interior 22 of the ornamental article, whereby the ornamental article 18 is fixed to the fixation member 19 via the tubular member 11a.

As shown in FIG. 1 and FIG. 8, the ornamental article fixing apparatus 10 according to this embodiment includes a placing portion 23 on which the fixation member 19 where the ornamental article 18 is aligned in position is placed, grip members 24a, 24b configured to grip and pull the shaft member 15 by the shaft member 15 being penetrated therethrough, and an operating lever 25 configured to cause the grip members 24a, 24b to pull.

A second embodiment of the ornamental article fixing apparatus according to the present invention will be described on points different from the first embodiment described above.

The second embodiment shows a mode in a case of fixing the ornamental article 18 such as, for example, a snap fastener to the fixation member 19 as shown in FIG. 21.

In other words, the ornamental article 18 includes one component part 100 arranged on one surface portion 102 of the fixation member 19 and one other component part 101 arranged on one other surface portion 103 of the fixation member 19.

As shown in FIG. 21, the tubular portion 11 is formed on the one component part 100 and is configured in such a manner that the other flange portion 14 as shown in FIG. 20 is formed at the other end portion 13 of the tubular portion 11 as shown in FIG. 19 when the shaft member 15 is pulled in one other component part 101 direction E along the axial direction as shown in FIG. 20, and the ornamental article 18 is fixed to the fixation member 19 by engagement of the other flange portion 14 with the other component part 101.

As shown in FIG. 18, the one component part 100 is arranged on the side of an upper surface 19a of the fixation member 19 and the other component part 101 is arranged on the side of a lower surface 19b of the fixation member 19 so as to oppose to each other in the vertical direction. A placing member 34 on which the fixation member 19 is placed via the other component part 101, the grip members 24a, 24b configured to grip the shaft member 15 arranged so as to penetrate through the one component part 100, the fixation member 19, and the other component part 101 as shown in FIG. 19 and pull the same downward, and the operating member 25 as shown in FIG. 17 configured to cause the grip members 24a, 24b to pull downward are provided. The head portion 16 of the shaft member 15 is arranged via a jig 108 placed on the one component part 100 as shown in FIG. 19. The placing member 34 is configured to have an abutting portion 106 which comes into abutment with the lower end portion 13 of the tubular portion 11 to widen the lower end portion 13 radially outward to be able to form the other flange portion 14 which is capable of engaging the other component part 101 when the shaft member 15 is pulled downward.

### Mode for the Invention 1

Subsequently, mode for the invention 1 according to the first embodiment will be described by exemplifying a case in which a cloth material is used as the fixation member.

As shown in FIG. 1 and FIG. 2, the ornamental article fixing apparatus 10 includes a seat portion 27 as a base plate portion which can be fixed on a fixing base 26 as a surface of installation, a column potion 28 provided uptight on an upper surface of the seat portion 27, a grip portion 20 formed into a substantially rectangular parallelepiped shape as a whole and provided continuously on the top of the column potion 28 also upright therefrom and including the grip members 24a, 24b arranged in the interior thereof so as to be movable in the vertical direction, a pull-down drive portion 29 having a pair of the grip members 24a, 24b in the interior of the grip portion 20, a collective box 30 arranged below the pull-down drive portion 29 and being capable of storing the shaft member 15a, and a operating lever 25 attached rotatably via a shaft to the grip portion 20, which is capable of rotating in the vertical direction in conjunction with the pull-down drive portion 29.

As shown in FIG. 6, the grip portion 20 includes a screw hole 31 on an upper surface thereof so as to allow detachable attachment of the placing member 34 having the placing portion 23 on an upper end thereof, the pull-down drive portion 29 is stored blow the screw hole 31, and the grip portion 20 is formed with openings 32a, 32b so as to penetrate through a side surface portions thereof extending in the longitudinal direction so as not to hinder a vertical rotational operation of the operating lever 25 stored so as to hold both radial end portions of the pull-down drive portion 29. The grip portion 20 is formed with a lower end opening 33 at a lower end thereof.

As shown in FIG. 6, the placing portion 23 is formed at the upper end portion of the placing member 34 which allows insertion of the shaft member 15, and the placing member 34 is formed into a cylindrical shape and includes a shaft insertion hole 60 at a center portion thereof, and includes a connecting tubular screw portion 35 which is engageable with the screw hole 31, a tubular stopper strip 36 provided on the top of the connecting tubular screw portion 35 and coming into abutment with the upper surface portion of the grip portion 20, and an inclined surface portion 37 provided on a lower end of the connecting tubular screw portion 35 having an inclined surface coming into abutment with upper end portions of the grip members 24a, 24b.

As shown in FIG. 6, the placing member 34 is formed so as to be detachably attachable by the connecting tubular screw portion 35, and is replaceable as needed according to the shape of a back surface of the ornamental article 18.

For example, when a back surface portion in a state in which the button 18 as the ornamental article is attached to the cloth material 19 has a flat surface as shown in FIG. 10, a placing member 67 in a form shown in FIG. 12(a) is used. When the back surface portion in the state in which the button 18 as the ornamental article is attached is a male member 70 of the snap fastener as shown in FIG. 13(a), a placing member 68 in a form shown in FIG. 12(b) is used. When the back surface in the state in which the button 18 as the ornamental article as shown in FIG. 13(b) is attached is a female member 71 of the snap fastner, a placing member 69 in a form shown in FIG. 12(c) is used.

As shown in FIG. 3, the pull-down drive portion 29 includes a substantially cylindrical case portion 38 having a holding portion 55 at the both radial end portions of an outer periphery thereof so as to be able to hold the operating lever 25, the grip members 24a, 24b stored in the interior of the case portion 38 as shown in FIG. 6, a pushing-up member 39 which is engageable with lower end portions of the grip members 24a, 24b, a screw member 40 having a screw groove which is with a lower end portion of the case portion 38, and a coil-shaped coil spring 41 arranged between a cylindrical projection 42 at a lower end portion of the pushing-up member 39 and a cylindrical projection 43 at an upper end portion of the screw member 40.

An inner peripheral surface of an upper portion of the case portion 38 includes an inner peripheral inclined surface 44 formed into a tapered shape widened as it goes down.

As shown in FIG. 6, the grip members 24a, 24b are formed into a substantially prefix truncated conical shape in vertical cross section as an entire part of the grip members 24a, 24b, and include a pair of grip portions 45, 45 with crests and troughs continuously opposed to each other and configured to be able to grip the shaft member 15 when the case portion 38 is pulled by the operating lever 25, upper inwardly inclined surface portions 46, 46 formed respectively at upper end portions so as to be able to come into abutment with the inclined surface portion 37 of the placing member 34, lower inwardly inclined surface portions 47, 47 formed respectively at lower end portions thereof so as to incline inwardly to allow abutment with an upper end portion of the pushing-up member 39, and an outer peripheral inclined surfaces 48 which function to reduce the distance between the grip members 24a, 24b by moving while being in abutment with the inner peripheral inclined surfaces 44, 44 by an urging force of the coil spring 41 by an operation of the operating lever 25.

In this configuration, the pushing-up member 39 is stored and arranged in the interior of the pull-down drive portion 29 in a state of being in press-contact with the grip members 24a, 24b by the urging force of the coil spring 41.

Therefore, the grip members 24a, 24b are configured in such a manner that when an upper end portion of the case portion 38 of the pull-down drive portion 29 is in abutment with an upper end of an inner side surface of the grip portion 20, the inclined surface portion 37 of the placing member 34 and the upper inwardly inclined surface portions 46 of the grip members 24a, 24b are brought into abutment with each other by the upward urging force of the coil spring 41, so that a space S is formed between the grip members 24a, 24b to allow insertion of the shaft portion 15, while when the case portion 38 is pulled downward by the operating lever 25, abutment between the inclined surface portion 37 of the placing member 34 and the upper inwardly inclined surface portions 46 of the grip members 24a, 24b is released, so that the shaft member 15 is gripped by the grip members 24a, 24b.

As shown in FIG. 6, the pushing-up member 39 and the screw member 40 are each formed into a cylindrical shape and have insertion holes 64, 65 respectively at the centers thereof to allow the insertion of the shaft member 15.

As shown in FIG. 3 to FIG. 5, the operating lever 25 includes a U-shaped member 50 configured to clamp the both radial end portions of the pull-down drive portion 29 from the side and fix the same, and a lever portion 53 configured to be joined and fixed to an opening end portion of the U-shaped member 50 via a fixing portion 52.

As shown in FIG. 3 and FIG. 4, opposed lateral side portions 51a, 51b of the U-shaped member 50 are rotatably supported by a spindle 54 which penetrates through the grip portion 20 from a widthwise side surface portion on one side to a widthwise side surface portion on the other side as shown in FIG. 4 and FIG. 5 at a portion of the U-shaped member 50 on the side of an end portion 58 of the U-shaped member 50 from a substantially lengthwise center portion and intersecting the grip portion 20.

Attached between the distal end portion 58 of the U-shaped member 50 which corresponds to a distal end portion of the operating lever 25 and the seat portion 27 is a coil spring 59, and the side of the distal end portion 58 of the operating lever 25 is constantly urged downward by the urging force of the coil spring 59, and the side of an operating side end portion 53a of the lever portion 53 is urged upward.

As shown in FIG. 3, the opposed lateral side portions 51a, 51b of the U-shaped member 50 are inserted into the openings 32a, 32b penetrating through the widthwise side surface portions of the grip portion 20. As shown in FIG. 3, the substantially lengthwise center portion of the U-shaped member 50 and the both radial side portions of the pull-down drive portion 29 engages with each other in a state of being clamped by the lateral side portions 51a, 51b.

As shown in FIG. 3, a pair of cam portions 56, 56 are formed at the substantially lengthwise center portion of the lateral side portions 51a, 51b of the U-shaped member 50, and recessed portions 57, 57 of a rectangular shape in side surface in which the cam portions 56, 56 are arranged are formed at the both radial side portions of the pull-down drive portion 29.

The cam portions 56, 56 are formed on widthwise both end portions of the U-shaped member 50 so as to have a predetermined length and include a pair of notched portions 50a, 50b formed by cutting inward from widthwise general surfaces of the U-shaped member 50 and arcuate portions 50c, 50d formed between these notched portions 50a, 50b.

The distance between the arcuate portions 50c, 50d is formed to be slightly smaller than the height of the recessed portions 57, 57.

Therefore, when the operating side end portion 53a of the operating lever 25 is rotated upward, the pull-down drive portion 29 is moved upward by sliding contact of the arcuate portion 50c with respect to upper edge portions 57a, 57a of the recessed portions 57, 57, while when the operating side end portion 53a of the operating lever 25 is rotated downward, the pull-down drive portion 29 is moved downward by sliding contact of the arcuate portion 50d with respect to lower edge portions 57b, 57b of the recessed portions 57, 57.

As shown in FIG. 11, the collective box 30 is detachable attached to the column. potion 28 via a mounting strip 66 and a slit 28a of the column potion 28.

Subsequently, an operation of mode for the invention 1 will be described.

A method of fixing the ornamental article 18 to the cloth material by using the ornamental article fixing apparatus 10 will be described with reference to FIG. 6 to FIG. 10.

As shown in FIG. 6, the grip members 24a, 24b provided in the interior of the pull-down drive portion 29 are urged upward via the pushing-up member 39 by the urging force of the coil spring 41.

Consequently, the upper inwardly inclined surface portion 44 of the grip members 24a, 24b and the inclined surface portion 37 formed at a lower end of the placing member 34 come into abutment with each other, so that the space S which allows insertion of the shaft member 15 is formed between the opposed pair of grip members 24a, 24b.

When fixing the ornamental article to the cloth material, as shown in FIG. 7, the tubular member 11a having the one flange portion 12 at the one end and the shaft member 15 arranged so as to penetrate through the tubular member 11a, formed to have the length larger than the length of the tubular member 11a, formed with the head portion 16 larger than the inner diameter of the tubular member 11a, and having the rigidity higher than the tubular member 11a are inserted into the shaft insertion hole 60 of the placing member 34, and a distal end portion of the shaft member 15 is positioned in the space S between the pair of grip members 24a, 24b.

In this case, the one flange portion 12 is placed on the placing portion 23.

Subsequently, as shown in FIG. 8, a washer 61 is inserted from the side of the head portion 16 of the shaft member 15, and is arranged on the one flange portion 12 placed on the placing portion 23. Then, the cloth material 19 is penetrated from the side of the head portion 16 of the shaft member 15 and arranged on the washer 61.

Then, a mounting hole portion 62 of the ornamental article 18 is inserted so that the head portion 16 of the shaft member 15 is arranged in the interior of the ornamental article and, if characters or the like is marked on a surface portion 63 of the ornamental article 18 and hence the direction of attachment is needed to be aligned with respect to the cloth material 19, the ornamental article 18 is rotated and adjusted.

When performing the adjustment in this manner, in the case of fixing work for the ornamental article in the related art, since the surface of the ornamental article 18 is in abutment with an ornamental article receiving member 95 and is covered by the cloth material 19 as the fixation member from above thereof as shown in FIG. 19, the surface of the ornamental article 18 cannot be viewed during the fixing work, and hence the confirmation of the direction of attachment or positional alignment of the ornamental article 18 is difficult. However, when the ornamental article fixing apparatus 10 according to the present invention is used, the component of the ornamental article fixing apparatus 10 does not exist above the ornamental article 18, and hence an operator is able to view the surface portion 63 of the ornamental article 18 directly, so that the confirmation of the direction of attachment of the ornamental article 18 is easy.

Subsequently, as shown in FIG. 9, the operating lever 25 is pulled downward with the upper portion of the ornamental article 18 held with a hand, the operating lever 25 is rotated about the spindle 54, the pair of cam portions 56, 56 rotate while engaging the pair of recessed portions 57, 57 as described above, and the pull-down drive portion 29 is pulled downward.

In this case, the case portion 38 held by the holding portion 55 is pulled downward and the grip members 24a, 24b are moved downward with the case portion 38. However, since the grip members 24a, 24b provided in the interior of the pull-down drive portion 29 are urged upward via the pushing-up member 39 by the urging force of the coil spring 41, the grip members 24a, 24b are relatively pushed upward while the outer peripheral inclined surfaces 48 of the grip members 24a, 24b and the inner peripheral inclined surface 44 being in abutment with each other, the abutment between the upper inwardly inclined surface portions 46 of the grip members 24a, 24b and the inclined surface portion 37 formed at the lower end of the placing member 34 is released.

Consequently, the distal end portion of the shaft member 15 is gripped by the grip members 24a, 24b and the outer peripheral inclined surfaces 48 of the grip members 24a, 24b and the inner peripheral inclined surface 44 of the case portion 38 are locked in a state of being in abutment.

By pulling the operating lever 25 further downward, the grip members 24a, 24b are moved downward while gripping the shaft member 15 and, since the shaft member 15 has the higher rigidity than the tubular member 11a, the other end portion 13 of the tubular member 11a as shown in FIG. 8 is formed with the other flange portion 14 created by the head portion 16 of the shaft member 15 being press-fitted into the tubular member 11a as shown in FIG. 9 when the shaft member 15 is pulled in the counter-ornamental article direction C along the axial direction by the pulling-down operation of the operating lever 25.

In this case, the shape of the other flange portion 14 to be created is different depending on the shape of the head portion 16 of the shaft member 15.

For example, when the head portion 16 has a substantially conical shape having a swelling portion swelling radially outward as a whole as shown in FIG. 15(a), the shape of the other flange portion 14 to be created is a radially swelled shape as shown in FIG. 16(a). In a case where the head portion 16 has a substantially conical shape and projecting grooves 72 are formed at four positions as shown in FIG. 15(b), the other flange portion 14 to be created has a shape in which four strips 14a, 14a, 14a, 14a are opened respectively to four directions as shown in FIG. 16(a).

Subsequently, by the pulling-down operation of the operating lever 53, the shaft member 15 and the head portion 16 are cut off in a state in which the shaft member 15a is held by the grip members 24a, 24b as shown in FIG. 9.

In this case since the apparatus is not configured to pressurize the ornamental article like the hand press machine in the related art, adjusting work for the ornamental article fixing apparatus 10 is not necessary.

Since the strength of attachment of the ornamental article 18 to the cloth material 19 is determined by the thickness and the quality of material of the tubular member 11a and the shaft member 15, and the breaking surface area or the like of the shaft member 15 and the head portion 16, the adjusting work relating to the ornamental article fixing apparatus performed in the related art is not necessary, and the tubular member 11a and the shaft member 15 are selected and used as needed according to the strength of the cloth material 19, the design of the clothes or the like.

Subsequently, when the operation of the operating lever 25 is stopped, the side of the distal end portion 58 of the operating member 25 is urged downward by the urging force of the coil spring 59 attached between the distal end portion 58 of the operating member 25 and the seat portion 27 as shown in FIG. 3.

Consequently, as shown in FIG. 6, the grip members 24a, 24b provided in the interior of the pull-down drive portion 29 are urged upward via the pushing-up member 39 by the urging force of the coil spring 39, and hence the upper inwardly inclined surface portions 46 of the grip members 24a, 24b and the inclined surface portion 37 formed at the lower end of the placing member 34 come into abutment with each other, so that the gripping state of the shaft member 15a of the grip members 24a, 24b is released and the space S which allows the insertion of the shaft member 15 is formed between the pair of opposed grip members 24a, 24b.

The griping state of the grip members 24a, 24b is released and, as shown in FIG. 2, the gripped shaft member 15a is dropped and passes through the insertion hole 64 of the pushing-up member 39 and the insertion hole 65 of the screw member 40, and is dropped into the collective box 30 via the lower end opening 33.

Since the collective box 30 is detachably attached to the column potion 28 by the mounting strip 66 as shown in FIG. 11, the shaft member 15a which is dropped into and hence is no longer necessary can be collected easily.

After having dropped the shaft member 15a, the operating side end portion 53a of the operating lever 25 is urged upward by the urging force of the coil spring 59 as shown in FIG. 6. Consequently, the grip members 24a, 24b provided in the interior of the pull-down drive portion 29 are urged upward via the pushing-up member 39 by the urging force of the coil spring 41, and the upper inwardly inclined surfaces 44 of the grip members 24a, 24b and the inclined surface portion 37 formed at the lower end of the placing member 34 come into abutment with each other, so that the space S which allows the insertion of the shaft member 15 is formed between the opposed pair of the grip members 24a, 24b.

In this manner, since the space S which allows the insertion of the shaft member 15 is formed between the opposed pair of the grip members 24a, 24b as described above, insertion and arrangement of the tubular member 11a and the shaft member 15 through the shaft insertion hole 60 of the placing member 34 is easily achieved.

In this manner, as shown in FIG. 10, the ornamental article 18 is fixed to the cloth material 19 by using the ornamental article fixing apparatus 10 via the tubular member 11a.

In a case of attaching the ornamental articles 18 as shown in FIGS. 13(a) to (e) and those shown in FIGS. 14(a) and (b) which allow movement of the upper portion of the ornamental article 18 as well, by using the ornamental article fixing apparatus 10, the ornamental articles 18 as shown in FIGS. 13(a) to (e) and FIGS. 14(a) and (b) can be fixed to the cloth material 19.

Therefore, there is provided the ornamental article fixing apparatus which does not require the adjusting work for the apparatus, does not damage the surface of the ornamental article during the work, is able to be used when the surface of the ornamental article is formed of glass, beads, or the like or when the upper portion of the ornamental article is movable, solves cost increase or complication owing to unnecessity of preparing the ornamental article receivers separately according to the surface shapes of the ornamental articles, achieves easy-to-work environment by preventing the work space from being narrowed, secures security, and is able to fix the ornamental article easily irrespective of the size of the cloth or the like used as the fixation member for the ornamental article.

### Mode for the Invention 2

Subsequently, mode for the invention 2 according to a second embodiment will be described about portions different from mode for the invention 1 described above. This example shows a case in which a female snap fastener 104 as the ornamental article is fixed to the cloth material 19.

In mode for the invention 2, as shown in FIG. 21, the female snap fastener 104 which is used as the ornamental article made up of the one component part 100 arranged on the one surface portion 102 of the fixation member 19 and the other component part 101 arranged on the one other surface portion 103 of the fixation member 19 can be attached to the fixation member 19.

As shown in FIG. 18, the one component part 100 is arranged on the side of the upper surface 19a of the fixation member 19 and the other component part 101 is arranged on the side of the lower surface 19b of the fixation member 19 so as to oppose to each other in the vertical direction. Mode for the invention 2 is configured to attach the female snap fastener 104 used as the ornamental article to the fixation member 19 by engaging the other flange portion 14 with the other component part 101 having a function of the female snap fastener as shown in FIG. 21.

The one component part 100 described above is formed into a substantially annular shape in plan view and, as shown in FIG. 18, includes an upper plain surface portion 115 on an upper surface thereof, includes the tubular portion 11 continuously provided so as to extend from an inner peripheral edge of the upper plain surface portion 115 vertically downward, includes the lower end portion 13 at a distal end of the tubular portion 11 before being fixed to the fixation member 19, and includes the other flange portion 14 formed at the lower end portion 13 of the tubular portion 11 as shown in FIG. 21 after having fixed to the fixation member 19.

The other component part 101 is formed into a substantially annular shape in plan view and, as shown in FIG. 18, includes a lower plain surface portion 121 at a lower surface thereof, includes a male snap fastener introducing tubular portion 120 provided so as to extend from an inner peripheral edge of the lower plain surface portion 121 vertically upward, includes an engagement strip 119 extending from an upper end portion of the male snap fastener introducing tubular portion 120 radially inward and being formed along the inner peripheral edge, and includes a pair of snap fastener spring portions 117, 117 which are able to lock a male snap fastener which forms a pair with the female snap fastener 104 at a lower end portion of the male snap fastener introducing tubular portion 120.

The placing member 34 of the ornamental article fixing apparatus 10 includes the connecting tubular screw portion 35 formed into a cylindrical shape, having the shaft insertion hole 60 at the center portion thereof as shown in a cross-sectional view in FIG. 17 and a perspective view in FIG. 22 and being engageable with the screw hole 31 of the grip portion 20 shown in FIG. 17, the hexagonal cylindrical tubular stopper strip 36 provided on the top of the connecting tubular screw portion 35 and being capable of coming into abutment with the upper surface portion of the grip portion 20, and the placing portion 23 provide at an upper end portion of the tubular stopper strip 36, a cylindrical mounting portion 105 provided on the top of the placing portion 23 and being capable of penetrating through a mounting hole 116 of the other component part 101 of the female snap fastener 104 as the ornamental article, an abutting portion 106 provided on the top of the mounting portion 105 and having an inclined surface inclining downward, and a cylindrical guiding tubular portion 107 provided continuously on the top of the abutting portion 106, having an outer diameter smaller than the diameter of the mounting portion 105 and having an outer diameter smaller than the inner diameter of the tubular portion 11 of the one component part 100 as shown in FIG. 18 on the upper end portion of the tubular stopper strip 36.

When attaching the female snap fastener 104 as the ornamental article having the configuration as shown in FIG. 18 to the fixation member 19, the jig 108 as shown in FIG. 19 is used.

As shown in FIG. 19, the jig 108 is formed into a cylindrical shape and has a hole portion 109 at a center portion thereof, and includes a cylindrical lower cylindrical portion 110 having a press-contact surface 113 which is capable of coming into abutment with the upper surface portion 115 of the one component part 100 of the female snap fastener 104 as the ornamental article, and a upper cylindrical portion 111 having a diameter smaller than the lower cylindrical portion 110 provided continuously from the lower cylindrical portion 110.

The hole portion 109 allows insertion of the shaft member 15, is formed with a locking portion 112 so as to be capable of locking the head portion 16 of the shaft member 15 extending from the inner peripheral edge radially inwardly on an upper end portion of the jig 108, so as to be capable of locking the head portion 16 when the shaft member 15 is inserted from above the hole portion 109 of the jig 108.

The hole portion 109 is formed to have a spatial portion 114 which allows storage of the guiding tubular portion 107 of the placing member 34 when the jig 108 is covered on the placing member 34.

Subsequently, an operation of mode for the invention 2 will be described.

A method of fixing the female snap fastner 103 as the ornamental article to the cloth material 19 as the fixation member by using the ornamental article fixing apparatus 10 as shown in FIG. 21 will be described with reference to FIG. 17 to FIG. 21.

When fixing the female snap fastener 104 as the ornamental article as shown in FIG. 21 to the cloth material 19, as shown in FIG. 17, the placing member 34 as shown in FIG. 22 is attached to the screw hole 31.

Subsequently, as shown in FIG. 18, the mounting hole 116 of the other component part 101 of the female snap fastener 104 is inserted from the side of the upper end of the placing portion 34 with the lower plain surface portion 121 face down so that the mounting portion 105 is locked radially by a snap fastener spring portion 117 of the other component part 101 and the lower plain surface portion 121 of the other component part 101 comes into abutment with an upper surface of the placing portion 23.

Then the cloth material 19 is penetrated from the upper end portion of the placing member 34 and arranged on the other component part 101.

Then, an insertion hole 118 of the one component part 100 is inserted from the side of the upper end the placing member 34 with the upper plain surface portion 115 faced up so as to oppose the other component part 101 via the cloth material 19, so that the one component part 100 is arranged with a distal end of the lower end portion 13 of the tubular portion 11 of the one component part 100 in abutment with an upper end of the abutting portion 106 of the placing member 34.

Then, as shown in FIG. 19, the shaft member 15 is inserted from above the hole portion 109 of the jig 108 and bring the head portion 16 of the shaft member into abutment with the locking portion 112 of the jig 108 to arrange the same on the top of the jig 108, and the shaft member 15 arranged on the top of the jig 108 is inserted into the shaft insertion hole 60 of the placing member 34 to arrange the jig 108 on the one component part 100 to bring the press-contact surface 113 of the jig 108 and the upper plain surface portion 115 of the other component part 101 into abutment.

Subsequently, the operating side end portion 53a of the operating lever 25 as shown in FIG. 17 is pulled downward with the upper portion of the head portion 16 of the shaft member 15 held with a hand, and the pull-down drive portion 29 is pulled downward as shown in FIG. 20.

In this case, the grip members 24a, 24b grip the distal end portion of the shaft member 15 by the pulling-down of the operating lever 25 as mode for the invention 1 described above, and the grip members 24a, 24b are moved downward while gripping the shaft member 15 by moving the shaft member 15 further downward.

As shown in FIG. 20, a pulling force generated by the shaft member 15 being pulled downward acts to press contact the upper plain surface portion 115 of the one component part 100 of the female snap fastener 104 from the press-contact surface 113 of the jig 108 via the locking portion 112 of the jig 108 which locks the head portion 16 and pushes the tubular portion 11 downward, so that the lower end portion 13 of the tubular portion 11 as shown in FIG. 19 comes into abutment with the inclined surface of the abutting portion 106 formed of an obliquely outwardly inclined surface as shown in FIG. 20 and is widened radially outward, and hence the other flange portion 14 as shown in FIG. 20 is formed at the other end portion 13 as shown in FIG. 19, whereby the other flange portion 14 engages the engagement strip 119 of the other component part 101.

Then, as shown in FIG. 20, by further pulling the operating lever 25 downward, the head portion 16 of the shaft member 15 is cut off in the state in which the shaft member 15a is gripped by the grip members 24a, 24b.

In this case, as shown in FIG. 20, since the spatial portion 114 which allows storage of the guiding tubular portion 107 is generated when the jig 108 is covered from the upper end side of the guiding tubular portion 107 of the placing member 34, the guiding tubular portion 107 does not come into abutment with the jig 108.

Then, fixation is completed by removing the head portion 16 and the jig 108 from the upper portion of the ornamental article fixing apparatus 10, and removing the female snap fastener 104 used as the ornamental article fixed to the fixation member 19, so that the female snap fastener 104 used as the ornamental article as shown in FIG. 21 can be fixed to the fixation member 19.

### Mode for the Invention 3

Subsequently, mode for the invention 3 will be described about portions different from mode for the invention 1 and 2.

As shown in FIG. 23 and FIG. 24, a working table 73 can be attached to the ornamental article fixing apparatus 10. The working table 73 is formed into a plate shape, and is provided on upright four leg portions 74, and includes an opening 75 for exposing the placing portion 23, and an upper surface of the working table 73 is arranged substantially flush with the placing portion 23.

Accordingly, even when the large cloth material 19 is used, the cloth material 19 can be handled easily, so that the ornamental article 18 can be fixed easily. In addition, the narrowing of the work space is avoided, and the ornamental article fixing apparatus which allows easy work is provided.

### Mode for the Invention 4

Subsequently, mode for the invention 4 will be described about portions different from mode for the invention 1 to 3.

As shown in FIG. 25, the ornamental article fixing apparatus 10 is capable of activating the operating lever 25 by an actuator 76.

The operating lever 53 of the operating lever 25 is removed, and an actuator 76 made up of a pneumatic cylinder 76 which is capable of pulling-down operation is attached to the lower side of one end portion of the operating rod 52 via a drive rod 77. The pneumatic cylinder 76 is connected to an air compressor 79 by an air tube 80 via a foot switch 78.

The ornamental article fixing apparatus 10 is configured in such a manner that the pneumatic cylinder 76 converts the air pressure energy into a linear motion and pulls the operating lever 25 downward by pressing the foot switch 78 downward.

Accordingly, the degree of freedom of hands of the operator is increased, and the fixation of the ornamental article 18 is facilitated, so that the working efficiency is increased.

Although the case in which the cloth material is used as the fixation member 19 of the ornamental article is exemplified for descriptions in the embodiments described above, the invention is not limited to the embodiments described above. The fixation member includes clothes, bags, shoes, curtains, and so on.

Although not described in the embodiments, the ornamental articles such as the button may be fixed to leather materials, paper materials, synthetic resin materials, sheet-type metallic materials, and the like by using the ornamental article fixing apparatus according to the present invention.

### INDUSTRIAL APPLICABILITY

The present invention may be applied widely to the ornamental article fixing apparatus and the method of fixing the ornamental articles with the fixing apparatus.

1. An ornamental article fixing apparatus configured to fix an ornamental article as a member to be fixed to a sheet-type fixation member comprising:
a tubular portion arranged through the fixation member;
one flange portion formed at one end portion of the tubular portion and arranged on the side of a surface portion on one side of the fixation member; and
a shaft member arranged so as to penetrate through the tubular portion and having a length longer than the length of the tubular portion,
whereby one other flange portion is formed at one other end portion of the tubular portion by pulling the shaft member along an axial direction of the tubular portion, and the ornamental article is fixed to the fixation member by the one flange portion and the other flange portion.

2. The ornamental article fixing apparatus according to claim 1, wherein the tubular portion is formed of a tubular member having the one flange portion at one end portion thereof, the shaft member has a head portion larger than an inner diameter of the tubular member and has rigidity larger than that of the tubular member,
the one flange portion is arranged in an exterior of the ornamental article and the head portion is arranged in an interior of the ornamental article, the fixation member is arranged between the ornamental article and the one flange portion,
the other flange portion is created by the head portion widening one other end portion of the tubular member when the shaft member is pulled in a counter-ornamental article direction along the axial direction, and the ornamental article is fixed to the fixation member via the tubular portion by the one flange portion fixed to one side of the fixation member and the other flange portion fixed to the interior of the ornamental article.

3. The ornamental article fixing apparatus according to claim 1, comprising: a placing portion on which the fixation member with the ornamental article aligned in position and arranged thereon is placed by the shaft member being penetrated therethrough; a grip member configured to grip and pull the shaft member; and an operating member configured to cause the grip member to pull.

4. The ornamental article fixing apparatus according to claim 1, wherein the ornamental article includes one component part arranged on one surface portion of the fixation member and one other component part arranged on one other surface portion of the fixation member, and
the tubular portion is formed on the one component part and is configured in such a manner that the other flange portion is created at the other end portion of the tubular portion when the shaft member is pulled in an other component part direction along the axial direction, and the ornamental article is fixed to the fixation member by engagement of the other flange portion with the other component part.

5. The ornamental article fixing apparatus according to claim 4, wherein the one component part is arranged on the side of an upper surface of the fixation member and the other component part is arranged on the side of a lower surface of the fixation member so as to oppose to each other in the vertical direction, comprising:
a placing portion on which the fixation member is placed via the other component part, a grip member configured to grip and pull the shaft member arranged so as to penetrate through the one component part, the fixation member, and the other component part downward, and an operating member configured to cause the grip member to pull downward are provided,
a head portion of the shaft member is arranged via a jig placed on the one component part, and
the placing portion includes an abutting portion which is capable of coming into abutment with a lower end portion of the tubular portion and widening the lower end portion radially outward, and forming as the other flange portion which is capable of engaging the other component portion when the shaft member is pulled downward.

6. The ornamental article fixing apparatus according to claim 1, wherein the fixation member has a thickness smaller than the length of the tubular portion.

7. The ornamental article fixing apparatus according to claim 6, wherein the fixation member is a cloth material.

8. The ornamental article fixing apparatus according to claim 6, wherein the fixation member is a leather material.

9. The ornamental article fixing apparatus according to claim 3, wherein the operating member is activated via a hand.

10. The ornamental article fixing apparatus according to claim 1, comprising:
a base plate portion to be fixed on a surface of installation;
a grip portion provided upright on the base plate portion and having the grip member arranged therein so as to be movable in the vertical direction;
an operating lever rotatably attached to the grip portion via a shaft and being capable of pulling the grip member downward;
an urging member arranged in the interior of the grip portion and being capable of urging the grip member constantly upward; and
the placing portion provided at an upper end portion of the grip portion.

11. The ornamental article fixing apparatus according to claim 3, wherein the operating member is activated via an actuator.

12. A method of fixing an ornamental article as a member to be fixed to a sheet-shaped fixation member comprising:
inserting a tubular portion into a fixation member and arranging a flange portion formed at one end portion of the tubular portion on the side of a surface portion on one side of the fixation member;
arranging a shaft member having a length larger than that of the tubular portion so as to penetrate through the tubular portion; and
arranging the ornamental article through the shaft member on the side of a surface portion on the other side of the fixation member,
forming one other flange portion at one other end portion of the tubular portion by pulling the shaft member along the axial direction of the tubular portion, and fixing the ornamental article to the fixation member by the one flange portion and the other flange portion.

13. The method of fixing an ornamental article according to claim 12, wherein the tubular portion is formed of a tubular member having the one flange portion at one end portion thereof, the shaft member has a head portion larger than an inner diameter of the tubular member and has rigidity larger than that of the tubular member,
the shaft member is arranged so as to penetrate through the fixation member by arranging the head portion in an interior of the ornamental article in a state in which the one flange portion is arranged in an exterior of the ornamental article and the fixation member is arranged between the one flange portion and the ornamental article, and the other flange portion is created by pulling the shaft member in a counter-ornamental article direction along the axial direction and causing the head portion to widen one other end portion of the tubular member, and the ornamental article is fixed to the fixation member via the tubular member by the one flange portion fixed to the one side of the fixation member and the other flange portion fixed to the interior of the ornamental article.

14. The method of fixing an ornamental article according to claim 12, wherein the ornamental article includes one component part arranged on one surface portion of the fixation member and one other component part arranged on one other surface portion of the fixation member, and comprising:
a step of forming the other flange portion at the other end portion of the tubular portion when the shaft member is pulled in the other component part direction along the axial direction with the tubular portion formed on the one component part and fixing the ornamental article to the fixation member by engagement of the other flange portion with the other component part.

15. The method of fixing the ornamental article according to claim 14, wherein the one component part is arranged on the side of an upper surface of the fixation member and the other component part is arranged on the side of a lower surface of the fixation member so as to oppose to each other in the vertical direction,
the shaft member is arranged with a head portion inserted through the one component part, the fixation member, and the other component part via a jig placed on the one component part, and
a lower end portion of the tubular portion is brought into abutment with an abutting portion formed on the placing portion to widen the lower end portion radially outward to form as the other flange portion which is capable of engaging the other component part when the shaft member is pulled downward, and the fixation member is clamped by the one flange portion and the other flange portion to fix the member to be fixed to the fixation member.
